(19) United States
(12) Patent Application Publication
(10) Pub. No.: US 2011/0007022 A1
(43) Pub. Date: Jan. 13, 2011

(54) TOUCH SURFACE SENSOR

(75) Inventors: Patrice Laurent, Annemasse (FR); Xavier Drouin, Annemasse (FR); Cedric Chartrain, Annemasse (FR)

Correspondence Address: OSHA LIANG L.L.P., TWO HOUSTON CENTER, 909 FANNIN, SUITE 3500, HOUSTON, TX, 77010, US

(73) Assignee: DAV, Creteil (FR)

(21) Appl. No.: 12/528,460

(22) PCT Filed: Feb. 14, 2008
(86) PCT No.: PCT/EP08/51812

§ 371 Date: Mar. 19, 2010

(30) Foreign Application Priority Data
Mar. 2, 2007 (FR) 0701563

(51) Int. Cl. G06F 3/045; G08C 21/00

(52) U.S. Cl. 345/174; 178/18.06

(57) ABSTRACT

The invention relates to a touch-surface sensor (1) that comprises a touch surface using pressure-sensitive resistors in a control area (2) defining at least one closed path, characterised in that the touch surface includes a first active strip (3) capable of providing a first signal (6a) to a processing unit (8) corresponding to a bearing area of a control finger applied on said first strip (3), and at least one second active strip (5) capable of providing a second signal (6b) to the processing unit (8) corresponding to the bearing area of a control finger applied on said second strip (5), said active strips (3, 5) being arranged so as to locate a bearing in the entire control area (2). The invention also relates to an electric control device comprising a touch-surface sensor (1) as described above.

The present invention relates to a sensor with a touch-sensitive surface using pressure-sensitive resistors (also known as FSR sensors for “Force Sensing Resistor”).

The invention also applies to a device for electric control via an FSR touch-sensitive surface, particularly for control devices of motor vehicles such as a motorized mechanism for opening and/or closing at least one opening element or an electronic member for a multimedia screen or an air conditioning system.

It has been proposed more recently to use, for these controls, touch-sensitive surfaces making it possible to detect a simple pressure of the finger in order to initiate a particular type of action or control, as for a control of a vehicle member, depending on the position of the pressure detected and/or of the subsequent movement of this pressure on the surface.

These touch-sensitive surfaces are increasingly using the technology of pressure-sensitive resistors, which are ahead of other equivalent technologies, such as for example capacitive or else optical technologies, by virtue of its ease of application and its robustness.

Such sensors are, for example, known by the name “digitizer pad” and documents U.S. Pat. No. 4,810,992, U.S. Pat. No. 5,008,497, FR 2683649 or else EP 0 541 102 are cited as the prior art.

These sensors comprise semiconductive layers sandwiched between, for example, a conductive layer and a resistive layer. By applying a pressure to the FSR layer, its ohmic resistance diminishes, thereby making it possible, by application of an appropriate voltage, to measure the pressure applied and/or to locate the place where the pressure is applied.

The coordinates delivered by the sensor are used to achieve the control of a specific electric function associated with the zone touched by the hand of a user.

In certain cases in which it is desired to detect a movement of the control finger in a closed line, such as a closed loop, sensors are in particular provided having a touch-sensitive surface of circular shape looping back on itself.

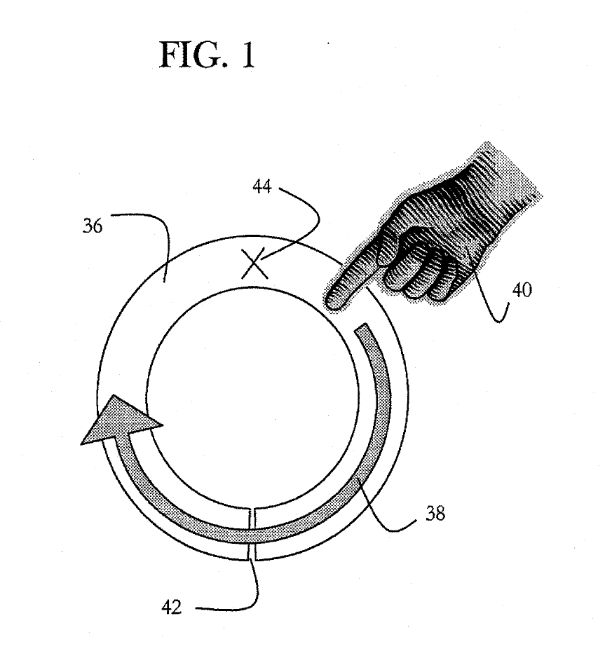

FIG. 1 of the prior art shows such a sensor, comprising a touch-sensitive surface 36 using pressure-sensitive resistors to detect a circular movement (arrow 38) of a control finger 40.

The coordinates of the control finger 40 are obtained by determining the barycenter of the pressure points of the pressure zone of the finger 40.

The disadvantage of this arrangement of the sensor is an error of interpretation of location of the finger 40 occurring when the finger 40 is positioned on the join 42 of the two ends of the loop formed by the sensor.

Specifically, when the control finger overlaps the two ends of the loop of the sensor, the real position of the finger no longer corresponds to the barycenter of the pressure points, which results in an incorrect location interpretation.

In FIG. 1, a position of the finger 40 on the gap 42, that is to say overlapping the two ends of the touch-sensitive surface 36, is interpreted by the sensor as a position situated at the barycenter of the two ends of the sensor, namely a position diametrically opposed to the real position of the finger 40, schematized by the cross 44.

The object of the present invention is therefore to propose a sensor with a touch-sensitive surface of the FSR type making it possible to detect a closed-line movement of the finger which does not have the drawbacks of the surface sensors of the prior art.

Accordingly, the subject of the invention is a sensor with a touch-sensitive surface comprising a touch-sensitive surface using pressure-sensitive resistors in a control zone forming at least one closed line, characterized in that the touch-sensitive surface comprises a first active strip capable of supplying a first signal to a processing unit corresponding to a pressure zone of a control finger applied to said first strip, and at least one second active strip capable of supplying a second signal to the processing unit corresponding to a pressure zone of a control finger applied to said second strip, said active strips being placed so as to be able to locate a pressure in the whole control zone.

According to other features of the sensor with a touch-sensitive surface:
each active strip has an annular shape that is open via a gap, the active strips being superposed so that the gaps are angularly offset from one another in the control zone,
two facing active strips have one support layer in common supporting on either side a track associated with each active strip,
the active strips are assembled in series,
the control zone has a polygonal shape,
the control zone has a circular shape,
at least one active strip has a circularly arcuate shape,
the active strips are substantially identical,
the control zone forms at least two closed lines and the active strips have substantially symmetrical shapes,
the control zone comprises two active strips,
the gaps between active strips have a width that is substantially smaller than the width of a pressure zone of a control finger,
at least two ends of active strips are placed end-to-end so that they are substantially parallel with one another and oblique relative to a direction moving from the center of the closed line,
at least two ends of one and the same active strip are substantially parallel with one another,
at least two ends of active strips placed end-to-end have a chevron shape.

A further subject of the invention is an electric control device, characterized in that it comprises a sensor with a touch-sensitive surface such as that described above.

Other advantages and features will appear on reading the description of the invention and the appended drawings in which:

FIG. 1 is a diagram of the sensor of the prior art explained above,

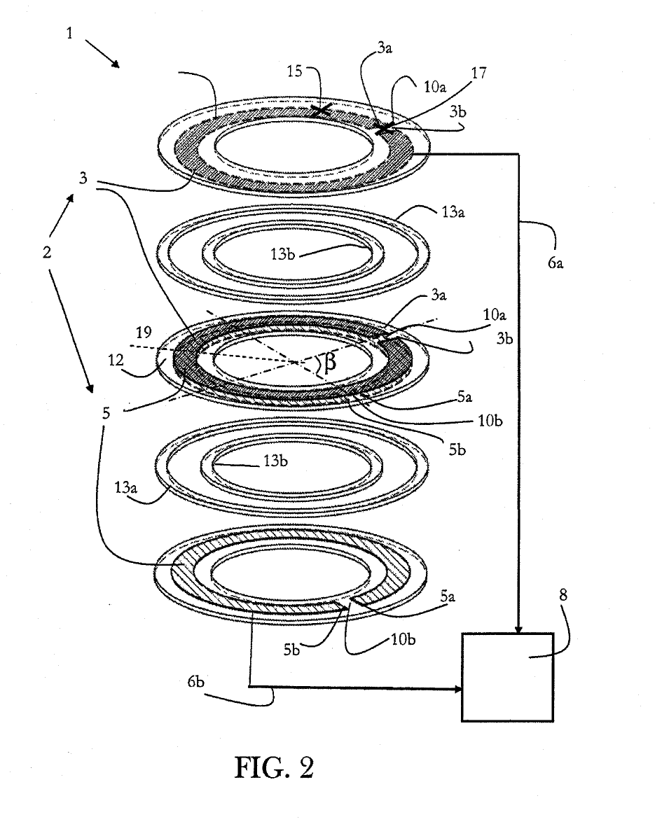

FIG. 2 is an exploded schematic view of a sensor according to a first embodiment of the invention,

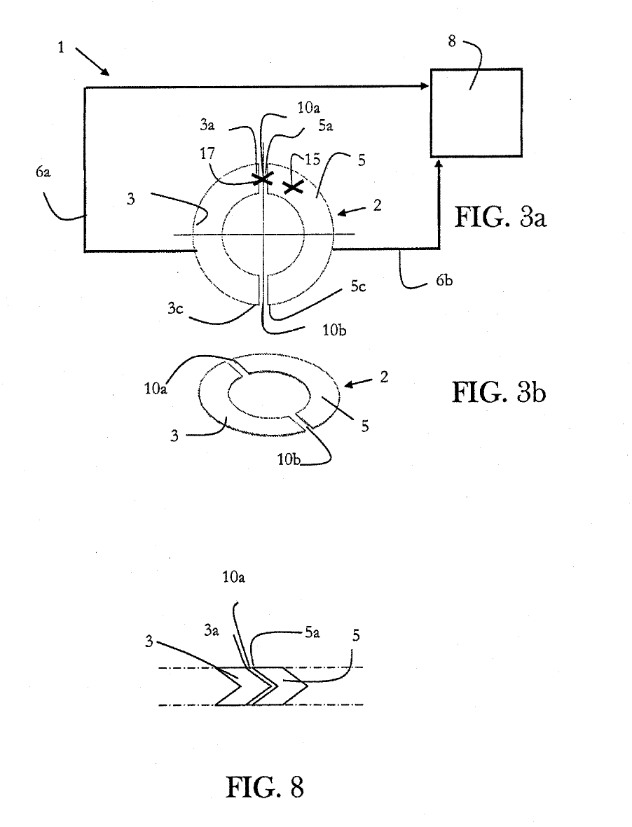

FIG. 3a is a schematic view of a second embodiment of the sensor according to the invention,

FIG. 3b is a view similar to FIG. 3a in perspective,

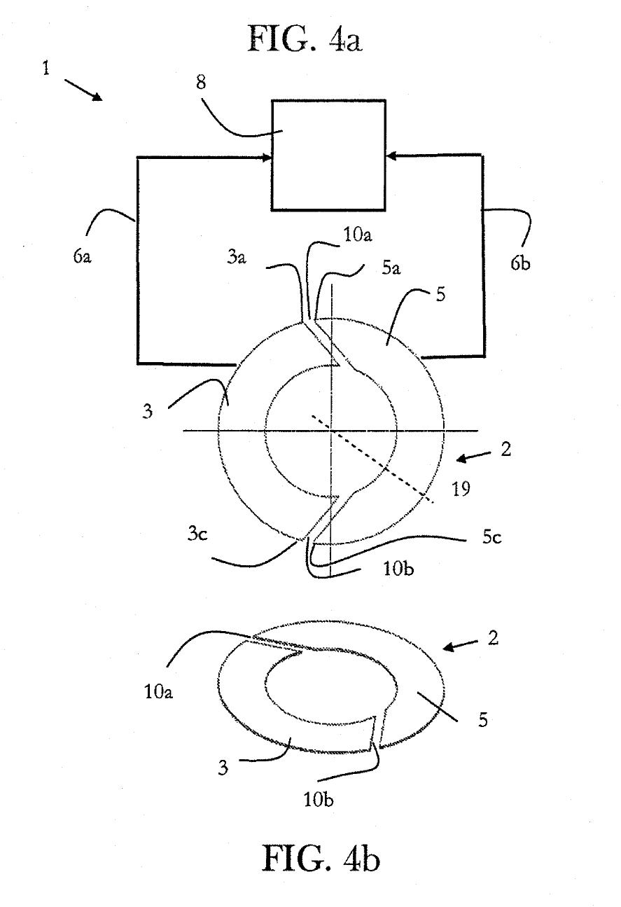

FIGS. 4a, 4b, 5a, 5b, 6a and 6b are schematic views from above and in perspective of variants of the second embodiment of the sensor according to the invention,

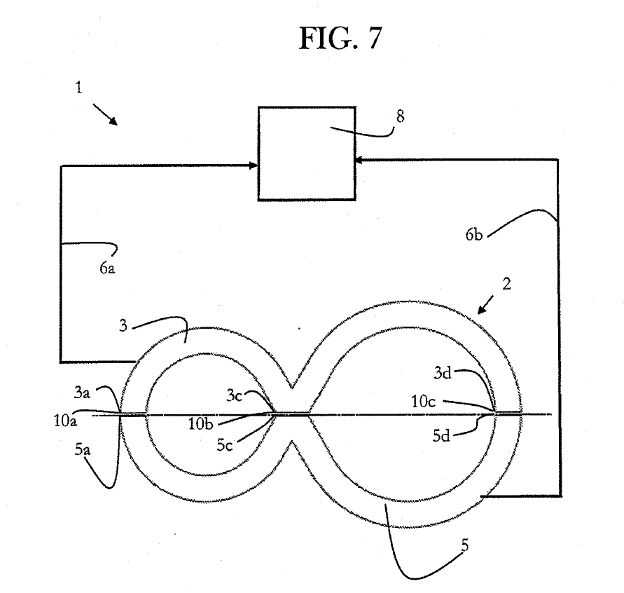

FIG. 7 is a schematic view of a third embodiment of the sensor according to the invention,

FIG. 8 is a diagram of a variant embodiment.

In these figures, the identical elements bear the same reference numbers.

FIG. 2 illustrates a sensor with a touch-sensitive surface 1 according to the invention, using pressure-sensitive resistors (also known as FSR sensor for “Force Sensing Resistor”).

This sensor 1 is particularly designed to be incorporated into a device for electric control by touch-sensitive surface of the FSR type, particularly for control devices of motor vehicles such as a motorized mechanism for opening and/or closing at least one opening element or an electronic member for a multimedia screen or an air conditioning system or any other electric control of a motor vehicle such as an electric seat control or light controls such as a dome reading light or background lighting.

The sensor with a touch-sensitive surface 1 comprises a touch-sensitive surface using pressure-sensitive resistors in a control zone 2 forming at least one closed line.

The touch-sensitive surface comprises a first active strip 3 capable of supplying a first signal 6a to a processing unit 8 corresponding to a pressure zone of a control finger applied to the first strip 3, and at least one second active strip 5 capable of supplying a second signal 6b to the processing unit 8 corresponding to a pressure zone of a control finger applied to the second strip 5.

A pressure zone corresponds to a pressure applied by a control finger in the control zone 2 changing the ohmic resistance of the active strip 3, 5.

By application of an appropriate voltage, the processing unit 8 measures the signal corresponding to the pressure applied and/or the position of the place where the pressure is applied to each active strip 3, 5 and determines the position of the pressure zone via the barycenter of the signals supplied for each active strip 3, 5.

The processing unit 8 then determines the correct position of the pressure zone in the control zone 2 by verifying the consistency of the two measurement signals.

The active strips 3, 5 are called “sliding” strips, that is to say that not only the pressure zone of a finger of the user is detected but also its movement, in particular the direction of movement of a finger of the user for a control in the “automatic” mode.

The active strips 3, 5 are placed so as to be able to locate a pressure in the whole control zone 2. This feature may be obtained with a control zone 2 comprising two active strips 3, 5.

In the first embodiment illustrated by FIG. 2, each active strip 3, 5 has an annular shape that is open via a gap 10a, 10b, the active strips 3, 5 being superposed so that the gaps 10a, 10b are angularly offset from one another in the control zone 2.

The active strips 3, 5 are offset at an angle β such that the gaps 10a, 10b of the superposed active strips 3, 5 do not overlap, so that a pressure zone cannot simultaneously overlap two gaps 10a, 10b and simultaneously supply two signals which would be misinterpreted by the processing unit 8.

To reduce the bulk and number of parts of the sensor 1, two facing active strips 3, 5 are made to have one support layer 12 in common supporting on either side a track associated with each active strip 3, 5.

The tracks may be made of graphite and obtained by screen printing. The layers of each active strip 3, 5 may be kept apart from one another by a spacer 13a, 13b formed by two concentric washers.

Therefore, when the finger of the user travels over the control zone 2, it presses simultaneously on the superposed active strips 3, 5, except when the finger overlaps the gap 10a, 10b of an active strip 3, 5.

For each position of the control finger in the control zone 2, each active strip 3, 5 supplies a signal 6a, 6b to the processing unit 8 in order to deduce therefrom a correct position of the control.

For example, when the control finger is positioned in the control zone 2 in the location schematized in FIG. 2 by the cross 15, the finger presses both on the top active strip 3 and the bottom active strip 5. Each active strip 3, 5 supplies a signal 6a, 6b to the processing unit 8.

This unit 8 determines a pressure position based on each received signal 6a, 6b. If the positions obtained by the two signals 6a, 6b match, the pressure position is validated and can be used subsequently by a control as described above.

If a difference appears between the two positions obtained, the processing unit 8, which has stored the barycenter position obtained when the user presses on the two ends, may reject this measurement by checking the consistency with the other measurement signal 6a, 6b, the position of which will be validated.

Let us now take the example in which the control finger is positioned in the location schematized by the cross 17. The finger is positioned in the gap 10a pressing on two ends 3a, 3b of the top active strip 3 and on the bottom active strip 5.

The processing unit 8 is programmed to recognize this situation and determine what is the correct interpretation of the position of the finger of the user.

This embodiment has the advantage of completely covering the control zone 2 so that the latter does not comprise any dead zone.

Furthermore, this embodiment does not cause any sensation for the user when the finger passes over the gaps 10a, 10b.

According to a second embodiment represented in FIGS. 3a and 3b, the active strips 3, 5 are assembled in series in at least one closed control line in order to locate a pressure in the control zone 2.

In this embodiment, the control zone 2 may have a polygonal, circular or any shape. The active strips 3, 5 then have matching shapes adapted for being assembled and covering the whole control zone 2. It is considered that the control zone 2 is covered even if it comprises at least two gaps 10a, 10b between the successive active strips 3, 5.

FIGS. 3a, 3b, 4a, 4b, 5a, 5b represent embodiments for which the control zone 2 has a circular shape. In this case, at least one active strip 3, 5 advantageously has a circularly arcuate shape.

Therefore, when the finger of the user travels over the control zone 2, it presses successively on the active strips 3, 5, sometimes overlapping a gap 10a, 10b.

For each position of the control finger, each active strip 3, 5 supplies a signal 6a, 6b to the processing unit 8 which deduces from it the position of the pressure zone.

For example, when the control finger is positioned in the control zone 2 in the location schematized in FIG. 3a by the cross 15 (FIG. 3a), the control finger presses on the active strip 5 and does not press on the active strip 3.

The active strip 5 returns a signal 6b corresponding to the pressure zone of the finger and the active strip 3 does not supply any signal or a signal 6a corresponding to the absence of pressure.

The processing unit 8 then has no difficulty in determining the correct position of the control finger.

In a second example, the control finger is positioned in the location schematized by the cross 17 of FIG. 3a, in the gap 10a, and presses simultaneously on two ends 3a, 5a of the active strips 3 and 5.

The active strip 3 returns a signal 6a corresponding to the pressure zone on the end 3a and the active strip 5 returns a signal 6b corresponding to the pressure zone on the end 5a, which allows the processing unit 8 to determine the correct position of the control finger.

This second embodiment has the advantage of being not very costly and easy to produce.

To make it still easier to produce and process the signal of the two previous embodiments, it is possible to have the active strips 3, 5 be substantially identical, as illustrated in FIGS. 2, 3b and 5b.

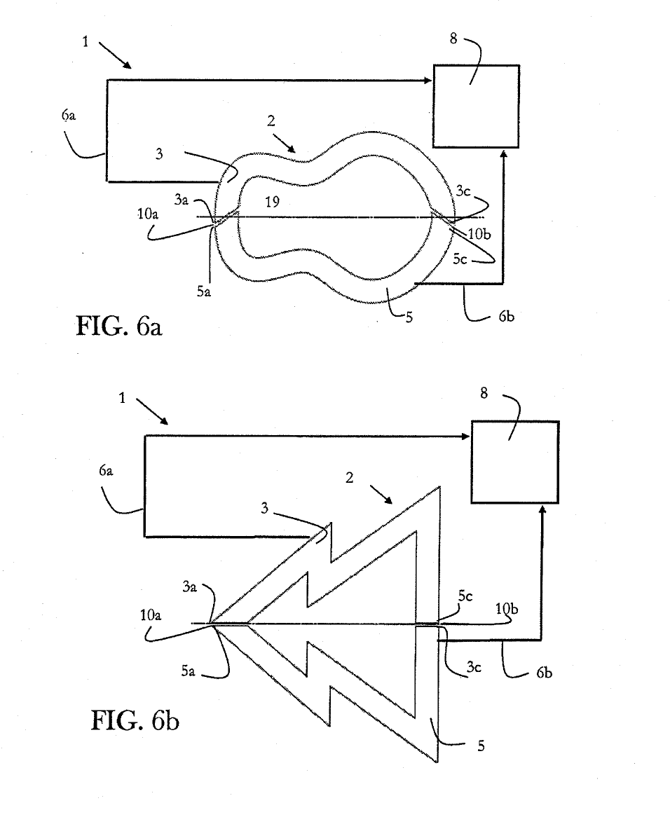

FIGS. 6a and 6b represent two other embodiments for which the active strips 3, 5 are assembled in series in a control zone 2 forming a closed line of any shape.

Alternatively, according to a third embodiment, the control zone 2 of the touch-sensitive sensor 1 forms at least two, preferably exactly two, closed lines, the active strips 3, 5 having substantially symmetrical shapes.

FIG. 7 illustrates this third embodiment for a control zone 2 forming two closed lines.

The control zone 2 comprises two active strips 3, 5. Each active strip 3 comprises three ends 3a, 3c, 3d in order to be assembled with the three ends 5a, 5c, 5d of the other active strip 5 forming three gaps 10a, 10b and 10c.

Advantageously, the gaps 10a, 10b, 10c between active strips 3, 5 have a width that is substantially smaller than the width of a pressure zone of a control finger, which makes it possible to limit the creation of dead zones.

Accordingly, in the variant embodiment illustrated in FIGS. 4a, 4b, 5a, 5b and 6a, the invention provides that at least two ends 3a, 3c, 5a, 5c of active strips 3, 5 are placed end-to-end so that they are substantially parallel with one another and oblique relative to a direction 19 moving from the center of the closed line.

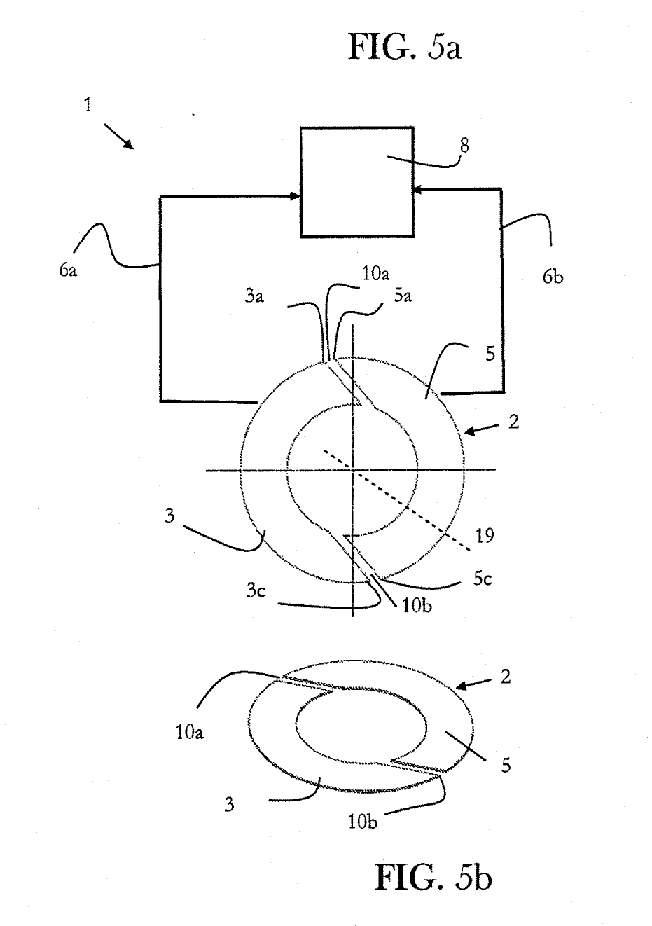

Alternatively and/or more particularly, and as illustrated in FIGS. 5a and 5b, at least two ends 3a, 3c, 5a, 5c of one and the same active strip 3, 5 are substantially parallel with one another.

In the embodiment illustrated in FIG. 8, at least two ends 3a, 5a of active strips 3, 5 placed end-to-end have a chevron shape.

Such a sensor 1 the touch-sensitive surface of which comprises a first active strip 3 and at least one second active strip 5, capable of supplying a signal 6a, 6b to a processing unit 8 corresponding to a pressure zone of a control finger applied to the active strip 3, 5 in question, the active strips 3, 5 being placed so as to be able to locate a pressure in any control zone 2, makes it possible to determine easily the barycenter of the pressure points of a pressure zone of the control finger situated in a gap 10a, 10b, 10c based on the barycenter read by each active strip 3, 5 of the sensor 1, which makes it possible to remove the incorrect interpretations of control.

1. A sensor with a touch-sensitive surface comprising:
a touch-sensitive surface using pressure-sensitive resistors in a control zone forming at least one closed line,
wherein the touch-sensitive surface comprises:
a first active strip capable of supplying a first signal to a processing unit corresponding to a pressure zone of a control finger applied to said first active strip, and
at least one second active strip capable of supplying a second signal to the processing unit corresponding to a pressure zone of a control finger applied to said second active strip, wherein said first and second active strips are placed so as to be able to locate a pressure in the control zone.

2. The sensor with a touch-sensitive surface as claimed in claim 1, wherein each active strip has an annular shape that is open via a gap, and wherein the first and second active strips are superposed so that the gaps are angularly offset from one another in the control zone.

3. The sensor with a touch-sensitive surface as claimed in claim 2, wherein the first and second active strips face one another, and wherein the two facing active strips have one support layer in common, supporting on either side a track associated with each active strip.

4. The sensor with a touch-sensitive surface as claimed in claim 1, wherein the first and second active strips are assembled in series.

5. The sensor with a touch-sensitive surface as claimed in claim 4, wherein the control zone has a polygonal shape.

6. The sensor with a touch-sensitive surface as claimed in claim 4, wherein the control zone has a circular shape.

7. The sensor with a touch-sensitive surface as claimed in claim 6, wherein at least one of the first and second active strips has a circularly arcuate shape.

8. The sensor with a touch-sensitive surface as claimed in claim 1, wherein the first and second active strips are identical.

9. The sensor with a touch-sensitive surface as claimed in claim 1, wherein the control zone forms at least two closed lines and the first and second active strips have symmetrical shapes.

10. (canceled)

11. The sensor with a touch-sensitive surface as claimed in claim 2, wherein the gaps between the first and second active strips have a width that is smaller than the width of the pressure zone of the control finger.

12. The sensor with a touch-sensitive surface as claimed in claim 1, wherein at least two ends of active strips are placed end-to-end so that they are parallel with one another and oblique relative to a direction moving from a center of the at least one closed line.

13. The sensor with a touch-sensitive surface as claimed in claim 1, wherein at least two ends of a same active strip are parallel with one another.

14. The sensor with a touch-sensitive surface as claimed in claim 1, wherein at least two ends of the first and second active strips placed end-to-end have a chevron shape.

15. An electric control device, wherein the electric control device comprises a sensor with a touch-sensitive surface as claimed in claim 1.
